(19) United States
(12) Patent Application Publication
(10) Pub. No.: US 2015/0066609 A1
(43) Pub. Date: Mar. 5, 2015

(54) PERSONALIZED INCENTIVE SYSTEMS, DEVICES, AND METHODS

(71) Applicant: Green Edge Technologies, Inc., Poway, CA (US)

(72) Inventors: Scott A. Steele, Poway, CA (US); William P. Alberth, JR., Prairie Grove, IL (US); David K. Hartsfield, Poway, CA (US); Seang Chau, San Jose, CA (US); William D. Rice, San Diego, CA (US)

(73) Assignee: Green Edge Technologies, Inc., Poway, CA (US)

(21) Appl. No.: 14/012,846

(22) Filed: Aug. 28, 2013

(51) Int. Cl. G06Q 30/02

(52) U.S. Cl. CPC G06Q 30/0207
USPC 705/14.1

(57) ABSTRACT

Automation systems and methods of use thereof are generally disclosed. The systems may control devices, and may monitor use of a utility and provide feedback related to the utility usage. More particularly, the present disclosure includes systems including personalized incentives to encourage responsible usage of a utility.

### FIELD OF THE INVENTION

Embodiments of the present disclosure are generally directed to systems, devices, and methods for incenting or otherwise encouraging/motivating persons or groups to conserve or otherwise reduce utility usage and save energy and resources.

### BACKGROUND OF THE INVENTION

Efforts to conserve energy have sparked interest in home automation. Existing technologies may include generalized platforms that fail to engage users and encourage a change in behavior to reduce energy consumption and/or choose alternative ways to perform tasks that use less energy or resources. Thus, there is a need for systems, devices, and methods capable of monitoring utility use and providing users with meaningful feedback to incentivize appropriate use of one or more utilities.

### SUMMARY OF THE INVENTION

The present disclosure is generally directed toward incenting, encouraging, and/or motivating utility users to conserve or otherwise reduce utility usage, e.g., to save energy.

In at least one embodiment, the present disclosure includes an automation system, comprising: a controller for determining a consumption of at least one utility, the controller comprising: a processor; and a database including a first account associated with a first utility consumer, wherein the first account includes a goal related to consumption of the at least one utility; a delivery device for delivering a supply of the at least one utility; and a measurement device for measuring consumption of the at least one utility; wherein the controller is configured to associate the consumption of the at least one utility with the first account and provide feedback related to the first account expressed in units related to the first utility consumer.

Embodiments of the present disclosure may include one or more of the following features: the units may be determined from a server, a social network, an authorized user, or the first utility consumer; the feedback may be related to an amount of the at least one utility consumed or saved by the first utility consumer; the feedback may include progress by the first utility consumer towards at least one of meeting the goal or earning a reward; the system may comprise at least one sensor for identifying the first utility consumer; the database may include a second account and the controller may be configured to divide the consumption between the first and second accounts; the controller may be configured to allocate an amount of the at least one utility consumed by a second utility consumer to the first account, wherein the second utility consumer may be at least one of a visitor, a friend of the first utility consumer, or an associate of the first utility consumer; the feedback may be related to a value of the at least one utility consumed; the at least one utility may include electricity, water, natural gas, telecommunications data, or telecommunications services; the controller may be configured to determine an amount of the at least one utility saved and donate the amount to a charity; the progress may be measured by an amount of the at least one utility consumed by the first utility consumer such that consuming less than a first amount increases progress towards meeting the goal or earning the reward, and consuming more than or equal to the first amount decreases progress towards meeting the goal or earning the reward; the progress may be measured by an amount of the at least one utility consumed by the first utility consumer such that consuming less than a first amount of the at least one utility decreases progress towards meeting the goal or earning the reward, consuming between a first amount and a second amount of the at least one utility increases progress towards meeting the goal or earning the reward, and consuming more than the second amount decreases progress towards meeting the goal or earning the reward; the system may comprise a user interface for displaying the feedback, wherein the user interface may include a computer, a tablet, a television, or a mobile device; or the feedback may include options for reducing the amount of the utility consumed or increasing the amount of the utility saved by the first utility consumer.

In at least one embodiment, the present disclosure further includes an automation system, comprising: a controller for determining consumption of at least one utility, the controller including: a processor; and a database including a first account associated with a first utility consumer; a delivery device for delivering a supply of the at least one utility; a measurement device for measuring a rate of delivery of the at least one utility; an outlet for providing electrical energy to an electrical device; and at least one sensor; wherein the controller is configured to associate the consumption with the first account and provide feedback related to the first account.

Embodiments of the present disclosure may include one or more of the following features: the at least one sensor may include a camera, a motion sensor, a sound sensor, a light sensor, a temperature sensor, a pressure sensor, a touch sensor, a radiofrequency (RF) sensor, an infrared (IR) sensor, or a power monitor; the controller may be configured to identify the first utility consumer based on data obtained by the at least one sensor; or the at least one sensor may be configured to detect an electrical device coupled to the outlet.

In at least one embodiment, the present disclosure further includes a method of monitoring utility consumption, the method comprising: delivering a supply of at least one utility; monitoring consumption of at least one utility with a measurement device, wherein the at least one utility includes electricity, water, natural gas, telecommunications data, or telecommunications services; identifying a first utility consumer based on data obtained by a sensor, wherein the sensor includes a camera, a motion sensor, a sound sensor, a light sensor, a temperature sensor, a touch sensor, a radiofrequency (RF) sensor, or an infrared (IR) sensor; associating the consumption with an account associated with the first utility consumer, wherein the account is stored in a database; and providing feedback related to the account, wherein the feedback is related to an amount of the at least one utility consumed by the first utility consumer and progress towards meeting a goal. In some embodiments, consuming less than a first amount of the at least one utility may increase progress towards meeting the goal; and consuming more than or equal to the first amount may decrease progress towards meeting the goal.

Various embodiments of automation systems disclosed may include one or more of the following features: at least one outlet including an adaptor configured to be operably coupled with a preexisting electrical outlet; at least one sensor, e.g., a plurality of sensors; the at least one sensor may include a motion sensor, a light sensor, or a temperature sensor; the outlet may include a processor or microprocessor; one of a control unit and the processor or microprocessor may be configured to receive power consumption data for one or more electrical devices from a power monitor; one of the control unit and the processor or microprocessor may be configured to compare the received power consumption data to power consumption data of known electrical devices; one of the control unit and the processor or microprocessor may be configured to identify the one or more electrical devices based on the comparison of the received power consumption data to power consumption data of known electrical devices; the at least one outlet may be configured to detect an electrical noise in a power line generated by the one or more electrical devices; the at least one outlet may be configured to communicate the detected electrical noise to the control unit; the control unit may be configured to compare the detected electrical noise to electrical noise data of known electrical devices; the control unit may be configured to identify the one or more electrical devices based on the comparison of the detected electrical noise to electrical noise data of known electrical devices; the sensor may be configured to detect a radiofrequency signal; a switch operably coupled to the controller and the outlet; the control unit may be configured to communicate with the Internet; or a communication link may be configured to allow wireless communication between the outlet and the control unit.

It may be understood that both the foregoing general description and the following detailed description are exemplary and explanatory only, and are not restrictive of the disclosure, as claimed. The present invention will be more clearly understood from the detailed description below in conjunction with the accompanying drawings.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 schematically illustrates an exemplary automation system, in accordance with an embodiment of the present disclosure.

FIG. 2 schematically illustrates an exemplary switch, in accordance with an embodiment of the present disclosure.

FIG. 3 schematically illustrates an exemplary outlet, in accordance with an embodiment of the present disclosure.

FIG. 4 illustrates an exemplary method, in accordance with an embodiment of the present disclosure.

FIG. 5 illustrates an exemplary user interface, in accordance with an embodiment of the present disclosure.

FIG. 6 illustrates an exemplary method, in accordance with another embodiment of the present disclosure.

### DETAILED DESCRIPTION

Reference now will be made in detail to embodiments of the present disclosure, examples of which are illustrated in the accompanying drawings. Wherever possible, the same reference numbers will be used throughout the drawings to refer to the same or like parts and/or components.

### Overview

An automation system, e.g., a home automation system, generally may include one or more switches and one or more outlets (or other suitable power delivery components), with the user desiring which outlet or outlets are controlled by the switch(es). Existing X10 devices require the user to manually set an address on the switch(es) and the outlet(s), wherein an outlet would respond to a switch with an identical address, e.g., the identically addressed switch may enable and/or disable power delivered from an outlet on command.

Embodiments of the present disclosure may include, among other things, an automation system. Examples of suitable systems include those described in U.S. application Ser. No. 13/672,534, filed Nov. 8, 2012, the entire disclosure of which is incorporated by reference herein. Systems according to the present disclosure may be used in, e.g., residential, commercial, and/or industrial structures. Non-limiting examples include single-family and multi-family dwellings, condominium units, apartments, apartment buildings, hospitals, nursing homes, cruise ships, offices, office buildings, schools, churches, sporting complexes, shopping centers, prisons, and manufacturing facilities.

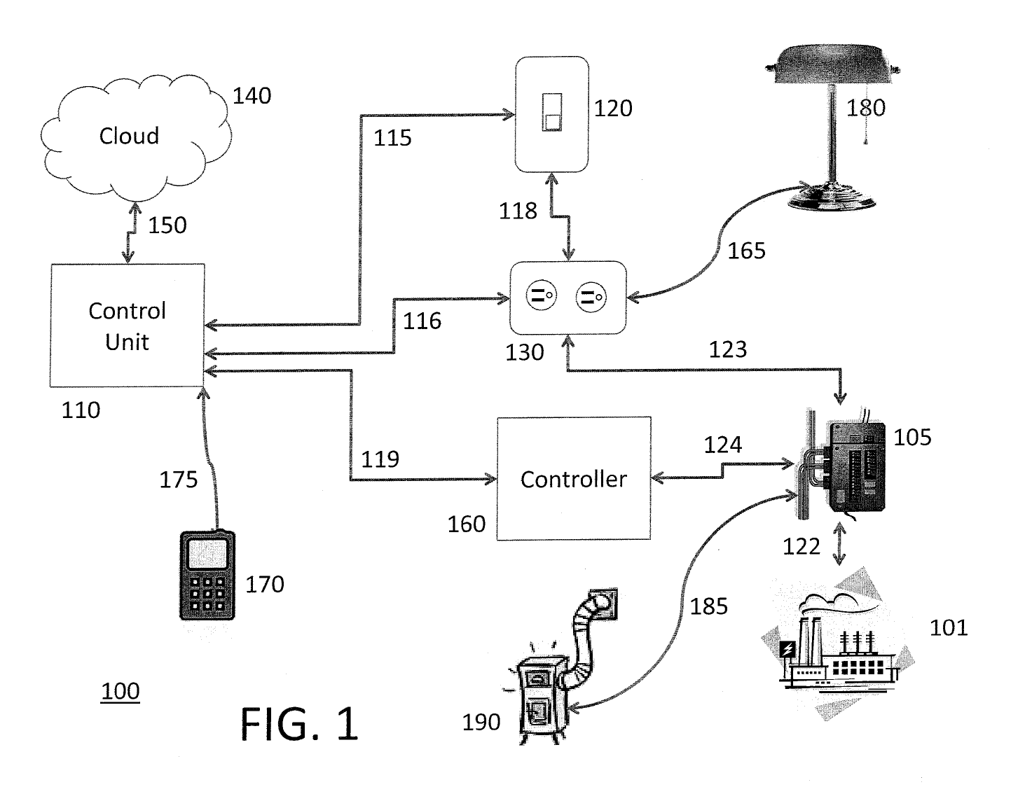

Embodiments of the present disclosure may be further understood with reference to FIGS. 1-6. In FIG. 1, for example, there is illustrated an automation system 100 including at least one outlet 130, which may be locally and/or remotely controlled. The outlet 130 may be configured to monitor the power consumed by one or more devices (e.g., appliances) connected thereto and/or to control power delivered by the outlet 130. The system 100 may further include a switch 120, which may send a signal (e.g., a wired or wireless signal) to a control unit 110. The control unit 110 also may be locally or remotely controlled and may include, for example, a computer with a microprocessor, memory, and user interface. The control unit 110 may be a discrete control unit, such as, e.g., a laptop, desktop, tablet, or any other suitable device. The control unit 110 may be connected via wired or wireless network connection 150 to the Internet cloud 140. The control unit 110 also may be connected to the switch 120 via wired or wireless connection 115, and further connected to the outlet 130 via wired or wireless connection 116. Similarly, the switch 120 may be connected to the outlet 130 via wired or wireless connection 118.

The system 100 may include one or more other components or enhancements. Referring to FIG. 1, for example, the automation system 100 may include a controller 160 that can control (e.g., adjust, open, close) window coverings. Controller 160 may be also configured to control other systems or enhancements associated with a home, office, school, or other structure. For example, controller 160 may control systems for irrigation, heating, cooling, entertainment, and/or water heating. In addition, controller 160 may control one or more safety systems. In some embodiments, the controller 160 may receive instructions from the control unit 110 via wired or wireless connection 119. For example, the controller 160 may receive instructions from the control unit 110 for controlling window treatments.

The switch 120 may also communicate with the controller 160, outlet 130, and/or one or more other components of system 100 via wired or wireless means (not shown). The wired or wireless connections, for example connections 115, 116, 118, and 119, may use the same or different protocols or standards. In some embodiments, switch 120 may communicate with outlet 130 through one or more devices of the system 100. For example, switch 120 may communicate with a second outlet (not shown) or other component of the system 100 through control unit 110, e.g., switch 120 may send a signal to control unit 110, and control unit 110 may send a signal to the second outlet. In some embodiments, switch 120 may send a signal to outlet 130, which may send a signal to the second outlet, thereby permitting communication between switch 120 and the second outlet. Other components of system 100 may similarly relay and/or send messages on behalf of one component, e.g., a first component, to another component, e.g., a second component. This may be beneficial (in some cases required), such as if a direct communication path between the first and second components does not exist.

In addition to instructions being processed by control unit 110, some or all of the processing could be performed by one or more microprocessors included in the switch 120, the Internet cloud 140, or the outlet 130. It is understood that the system 100 may include multiple switches 120, outlets 130, and/or controllers 160, e.g., window control units. Other devices such as sensors may be in communication with the system 100 to provide information. In some embodiments, for example, the system may include or otherwise be in communication with a moisture sensor for providing information on the presence of water, e.g., humidity, rain, snow, or other precipitation. Each of the outlet 130, switch 120, control unit 110, and controller 160 may include one or more features of the outlet, switch, control, and controller, respectively, described in U.S. application Ser. No. 13/672,534, filed Nov. 8, 2012, which is incorporated herein by reference in its entirety.

A mobile device 170 may be wirelessly connected to the system 100 via wireless connection 175. For example, the mobile device 170 may be connected to the control unit 110 as shown in FIG. 1, and/or may be connected to the outlet 130, controller 160, switch 120, another device connected to the automation system 100, or any combinations thereof. The mobile device 170 may include a wireless transceiver, which provides means to measure received signal strength. The mobile device 170 may include any suitable means of collecting, recording, analyzing, and/or transmitting data in order to locate, characterize, and/or otherwise identify one or more devices or components of the automation system 100. In some embodiments, for example, the mobile device 170 may include a heat sensor and/or an RF sensor. Further, in some embodiments, the mobile device 170 may include an imaging device, e.g., a camera, for taking and transmitting pictures or other suitable images. The mobile device 170 may include means for determining location and/or orientation information. Non-limiting examples of such technology include GPS, accelerometers, compasses, and gyroscopes. The mobile device 170 may collect data to determine the orientation of the camera when taking a picture, e.g., whether the camera is pointed towards a ceiling, a floor, or a wall. The geographic location and cardinal direction of the camera may also be determined via a compass, GPS, and/or other suitable data collected by the mobile device 170. In addition to instructions being processed by control unit 110, some or all of the processing could be performed by mobile device 170. Suitable methods of collecting and processing such information are described in U.S. application Ser. No. 13/766,123, filed Feb. 13, 2013, which is incorporated herein by reference in its entirety. In at least one embodiment, the mobile device 170 may include a smart phone.

Further referring to FIG. 1, power may be generated at power plant 101, and transmitted to a home meter or breaker box 105 via, for example, wired transmission lines 122. The methods presently disclosed also may be applied to other utilities and/or alternative energy sources such as, e.g., water, natural gas, steam, heat, solar, wind, geothermal, algal, biomass, telecommunications data or services (e.g., Internet, television, cable, voice, telephone, radio, broadband, broadcasting, etc.), or any other utility or resource. Power may be routed to the outlet 130 by wires 123, and routed to controller 160 via wires 124. Power may be further routed to a heating ventilation and air conditioning (HVAC) system 190 via wire 185. It is also expected that power could be transmitted wirelessly and one or more of wires 122, 123, 124, and/or 185 could be replaced with wireless transmission methods. Each set of transmission wires, such as wires 123, may be referred to as a circuit. A circuit may, for example, be connected to and provide power to multiple devices, e.g., via multiple outlets 130. In some embodiments of the present disclosure, the system includes one or more circuits, e.g., circuit 123.

Breaker box 105 may measure voltage, current, and/or power on one or more power lines leading into and out of the breaker box 105. Breaker box 105 may, for example, include a utility meter. Breaker box 105 may be wire- or wirelessly-connected to automation system 100, and may include one or more sensors such as voltage meters, current meters, temperature sensors, or other types of sensors. The sensor(s) may be wire- or wirelessly-connected to the automation system 100.

An appliance 180 such as, e.g., a desk lamp, may be plugged into or otherwise operably coupled to an outlet 130 or other suitable power delivery component through connection 165, which may be wired or wireless. The appliance 180 may be able to communicate with system 100, with other appliances, with the internet, and/or another entity, and the appliance 180 may have the ability to measure the amount of power drawn from outlet 130.

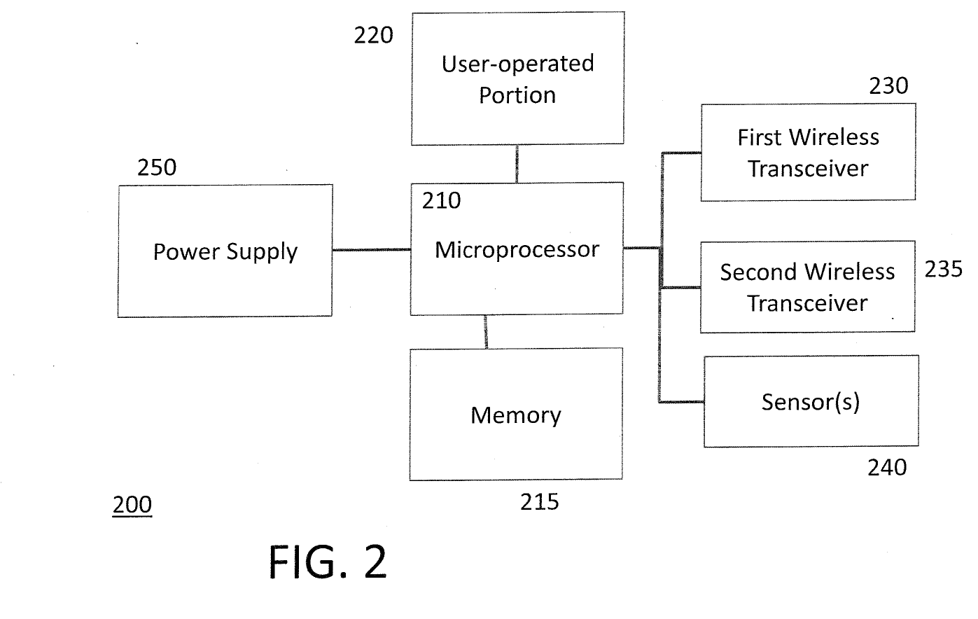

FIG. 2 shows a block diagram for a switch 200 that may be used in the automation system 100 and may operate as the switch 120 in FIG. 1. Switch 200 may be any suitable actuator known in the art. In at least some embodiments, the switch 200 may be remotely controlled. The switch 200 may include a microprocessor 210 capable of running software or an algorithm stored in memory 215. Memory 215 may be, e.g., solid state or flash memory, or any other suitable type of memory. The switch 200 may include a user-operated portion 220, such as a mechanical light switch. In some embodiments, the switch 200 includes one or more user input devices, including, for example, a touch sensor, a touch screen, and/or push buttons. User-operated portion 220 may be configured to control (e.g., interrupt, adjust, change, terminate and/or meter) the supply of energy to a device or an outlet (e.g., outlet 130 shown in FIG. 1) in communication with switch 200. In at least some embodiments, the user-operated portion 220 is configured to control the supply of electrical energy to a device or outlet 130. Accordingly, in one embodiment, the user-operated control portion 220 may be configured to transition between an “on” position and an “off” position (i.e., supplying and terminating power, respectively). In some embodiments, the switch 200 may allow various levels to be controlled by the user discretely or continuously (e.g., increasing or decreasing power supply). That is, user-oriented control portion 220 may be configured to provide a dimming function.

The switch 200 may further include a first wireless transceiver 230, for example, a 802.11 Wi-Fi transceiver. The term “transceiver” as used herein should not be construed as limited to any particular structural components. Instead, a transceiver may include any structural components configured to allow for back and forth communication, e.g., communication exchange. Accordingly, the transceivers disclosed herein may include, but are not limited to, antennae, power supplies, communication ports, and/or any other elements needed to achieve the desired function. The first wireless transceiver 230 may be configured to communicate over any known protocol including, but not limited to, X10, Zigbee®, and/or Bluetooth. Further, although the exemplary embodiment of FIG. 2 depicts the transceiver 230 as a wireless transceiver, those of ordinary skill will readily recognize that first wireless transceiver 230 may be replaced with a wired communication mode. First wireless transceiver 230 may allow the switch 200 to communicate with a control device, e.g., the control unit 110 as shown in FIG. 1. The first wireless transceiver 230 therefore may allow the switch 200 to exchange one or more commands with the control unit 110 of the automation system 100.

In some embodiments, the switch 200 may also include a second wireless transceiver 235 to allow the switch 200 to communicate with one or more devices (e.g., the outlet 130 shown in FIG. 1 and/or any electrical load coupled thereto) using multiple standards. Both transceivers 230 and 235 may include received signal-strength indicator means to identify the strength of a signal received by the transceiver. The first and second wireless transceivers 230, 235, respectively, may allow for communication over one or more protocols including, but not limited to, the aforementioned protocols. In addition, the first wireless transceiver 230 may be configured to communicate over a protocol that is different from the communication protocol of the second wireless transceiver 235.

The switch 200 may include one or more sensors 240 configured to detect and/or respond to various conditions or stimuli, such as temperature, moisture (e.g., water, rain, or humidity), light, sound, air flow, contaminants, motion, or electromagnetic or radio frequencies. Examples of such sensors are disclosed in U.S. application Ser. No. 13/672,534 filed Nov. 8, 2012, which is incorporated herein by reference. The sensor may include a camera, imager, and/or infrared (IR) sensor. The sensor(s) may be used to detect and/or identify persons, animals, and/or objects in the vicinity of the switch 200. In some embodiments, for example, the sensor(s) and may be used to identify a person actuating the switch 200. Data from the sensor(s) may be processed in the switch 200 and/or via another device coupled to system 100. The processing may include comparing the sensor data to sensor data stored locally or remotely in a database to determine an identity, such as the identity of the most likely person to be in the vicinity of the switch 200, or the most likely person to actuate the switch 200. The sensor may include an algorithm or software to identify a person, e.g., via physical characteristics such as facial recognition or fingerprint, or auditory characteristics such as voice recognition, or may communicate with one or more other components of system 100 to identify a person through physical and/or auditory characteristics detected by the sensor.

The sensor data may be sampled at a periodic or aperiodic rate, which may increase in response to stimuli (e.g., if one or more persons are in the vicinity of the switch 200) and decrease in the absence of stimuli (e.g., when persons are not in the vicinity of the switch 200). The sensor may sample, e.g., collect, store, and/or display, data upon actuation of the switch 200.

One or more transceivers may communicate with a device associated with a person, such as a mobile device 170, e.g., smart phone, discussed above in reference to FIG. 1. By communicating with mobile device 170 and/or by monitoring a signal emitted from mobile device 170, switch 200 may determine that mobile device 170 is near the switch 200. This may be determined by any suitable means, such as by measuring the strength of the signal emitted by mobile device 170, by measuring the time delay of a message from mobile device 170, or by other means known in the art. One or more components of system 100 may recognize an association between mobile device 170 and one or more persons, for example, associate mobile device 170 with a particular owner or operator. If switch 200 detects that mobile device 170 is in the vicinity of the switch 200, then system 100 may determine or otherwise understand that the owner or operator of mobile device 170 is also in the vicinity of switch 200.

The switch 200 may include a power supply 250, which may be any suitable power supply known in the art. In some embodiments, for example, the power supply 250 includes a battery, e.g., a rechargeable battery. It is understood that the power supply 250 in FIG. 2 may schematically illustrate a wired or wireless connection to a power network, such as, e.g., a power grid or transformer. Further, the power supply 250 may include both a battery and a connection to a power network. The power supply may provide power needed to operate the first wireless transceiver 230, second wireless transceiver 235, sensors 240, as well a the microprocessor 210 and memory system 215.

The switch 200 may include a microprocessor 210, which may be any suitable microprocessor known in the art. Although FIG. 2 shows the microprocessor 210 located within the switch 200, in some embodiments the microprocessor 210 may be remotely connected to the switch 200. The microprocessor 210 may be configured to communicate, e.g., exchange control signals, with the one or more sensors 240, the first wireless transceiver 230, the second wireless transceiver 235, and/or the user-operated portion 220 of switch 200.

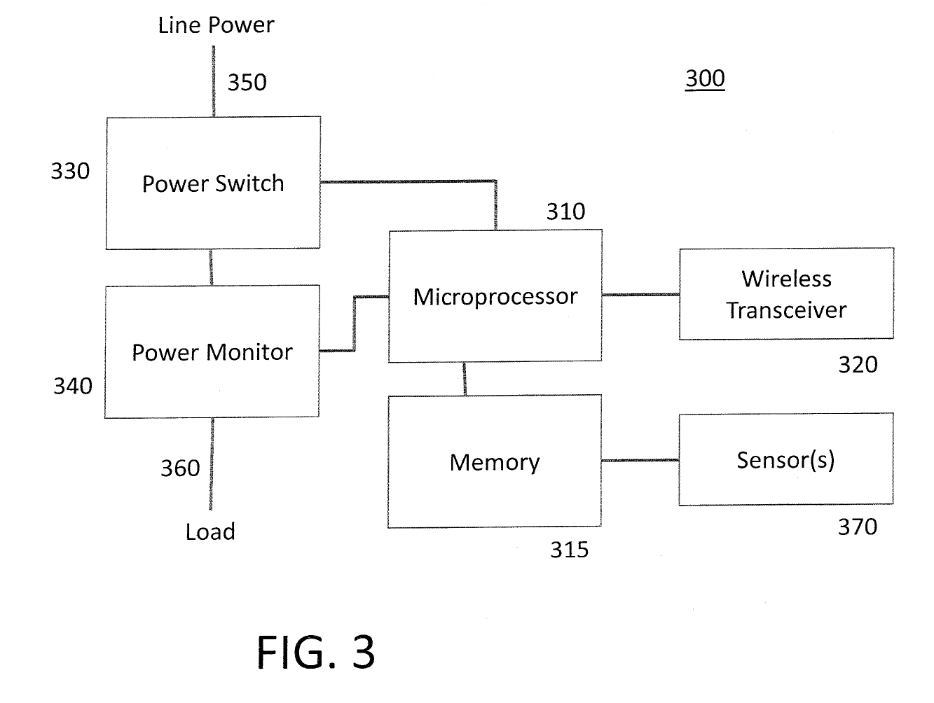

FIG. 3 shows a block diagram of an outlet 300 that may operate as the outlet 130 of the system 100 shown in FIG. 1. In at least some embodiments, the outlet 300 is remotely controlled. The outlet 300 may include a microprocessor 310 that runs software or an algorithm stored in memory 315. The microprocessor may be remotely connected to the outlet 300. The outlet 300 further may include a transceiver 320, which may include any of the features described in connection with transceivers 230 and 235 of FIG. 2. The outlet 300 also may include one or more sensors 370, which can include, e.g., motion sensors, voltage sensors, current meters, ambient light sensors, cameras, microphones, moisture sensors, or any of the sensors described above with respect to the one or more sensors 240 of FIG. 2. The sensors may allow at least one of voltage and current to be measured at connection 350 with a power source.

In some embodiments, the outlet 300 receives electrical energy via a power switch 330 supplied by line power via connection 350. The power switch 330 may be controlled by a microprocessor, e.g., microprocessor 310, which may include any of the features described with respect to the microprocessor 210 of FIG. 2. The power switch 330 may be configured to connect and/or disconnect the line power to the outlet 300, including a connected load 360 (e.g., one or more electrical devices coupled to the outlet 300). The power switch 330 may be configured to increase and/or reduce a voltage or current delivered to the load 360, thus providing a dimming function.

The outlet 300 may further include a power monitor 340 for measuring the consumption of power by the load 360 connected to the outlet 300. The load 360 may be connected via any suitable means, such as, e.g., standard 2 or 3 pin power outlets, 220V outlets, or international standard outlets, and may also include a wireless connection such as via a wireless charger. The power monitor 340 may transmit measured power data to the microprocessor 310 via the transceiver 320, or may also transmit data to one or more other components or devices of the system 100.

In some embodiments, the power monitor 340 measures noise in the connection to the load 360 in order to determine the type of energy-consuming device(s) connected. See, e.g., U.S. application Ser. No. 13/672,534, filed Nov. 8, 2012, which is incorporated herein by reference. This type of analysis is discussed, for example, in U.S. Pat. No. 8,094,034. Multiple connections throughout an entire structure may be monitored and analyzed to determine the types of devices, such as appliances, connected to define the load 360, e.g., by turning the devices on and off. In some embodiments, user activity may be inferred by monitoring a structure, e.g., identifying which loads are activated and deactivated. By monitoring power consumption characteristics of the load 360, one or more characteristics of a device connected to the outlet 300 may be determined, e.g., via techniques disclosed in U.S. Pat. No. 8,094,034 or other suitable analytical methods. Based on the power consumption characteristic(s), the device (e.g., an oven, refrigerator, fan, or other appliance) may be beneficially and intelligently identified and controlled.

In some embodiments, the outlet 300 may be connected to an appliance at 360 (i.e., an appliance as the load 360). The appliance may have a power switch similar to power switch 330 of the outlet 300 to turn the appliance on or off and/or to place the appliance in an intermediate state, such as dimming, standby, or another reduced energy consumption state. The appliance power switch 330 may control power to the appliance, e.g., supply and/or terminate or disable power to the appliance. In some embodiments, the outlet 300 may monitor the state of the appliance to determine if the appliance power switch has been actuated. One method of determining actuation of the appliance power switch is to measure the resistance of the appliance, i.e., the resistance of the load 360 connected to the outlet 300. For example, a relatively small amount of electrical current or voltage may be supplied to the appliance and resistance measured, e.g., with an ohmmeter or other suitable device. If the appliance power switch is set to turn the appliance on, the appliance may present a relatively low impedance to the supplied current/voltage, whereas if the power switch is set to turn the appliance off, the appliance may present a relatively high impedance. By measuring the impedance of the load 360, the outlet 300 may determine the state of the appliance power switch and determine if the state of the switch has changed.

The outlet 300 may have electrical and/or mechanical capability of determining whether a plug is connected to a socket of the outlet 300. For example, the outlet 300 may include an electrical sensor and/or mechanical mechanism for detecting a connection or otherwise detecting the presence of a plug within or otherwise coupled to outlet 300. Such sensors may include, but are not limited to, proximity sensors, imagers, cameras, etc. Further, the outlet 300 may include a radiofrequency (RF) sensor for detecting an RF signal emitted by a plug, e.g., if the plug is sufficiently close to the outlet 300. Other suitable means of detecting and/or identifying whether an appliance or other device is connected to the outlet 300 may be used as known to those of ordinary skill in the art.

If the outlet 300 recognizes or detects a connection, e.g., determines that a plug is connected to the socket of outlet 300, or detects a wireless connection to an appliance, the outlet 300 may monitor the state or condition of the appliance, e.g., whether the appliance is turned on or turned off. In some embodiments, for example, the outlet 300 may monitor the appliance continuously for a change in state.

In some embodiments, the outlet 300 may monitor whether an appliance operably coupled to the outlet 300 is turned on, turned off, or placed in an intermediate state when a person is determined to be in the vicinity of the appliance. For example, the outlet 300 may include a sensor 370 that may determine that a person is in a given area or radius of the appliance. Alternatively, or in addition, a sensor otherwise connected to the automation system 100 such as sensor 240 may determine that a person is in the area of the appliance. For example, a person may be in the same room as the appliance, in the same house or structure as the appliance, or within a certain predetermined distance of the appliance, such as, for example, from about 1-10 feet, e.g., within about 3 feet or 5 feet. The presence of a person may be determined by any suitable method, including, but not limited to, a motion sensor, a camera, or the presence of a mobile device, e.g., mobile device 170. In some embodiments, for example, the automation system 100 may determine the presence or identity of a person by determining the location of a mobile device 170. In other embodiments, the automation system 100 may detect the presence of a person by detecting one or more other components of the system 100 being turned on, turned off, or otherwise adjusted in a given area. For example, the system 100 may detect a light being turned on and determine that a person is near the light. If no one is detected within the vicinity of the appliance, the outlet 300 may not conduct any monitoring, or may monitor the appliance periodically.

In some embodiments, system 100 may send instructions to one or more components of system 100 to detect and/or identify a person. For example, if a switch 200 is known to be near outlet 300 and/or another device of system 100, and if any of the devices detect the presence of a person, the system 100 may send instructions via switch 200 to one or more devices in the vicinity of the person, e.g., all devices in the vicinity of the person, to attempt to detect and identify the person. In some embodiments, system 100 may send instructions directly to one or more devices in the vicinity to attempt to detect and identify the person.

In some embodiments, the outlet 300 may periodically check if a power switch on the appliance has been actuated. For example, the outlet 300 may monitor the appliance every 5 minutes, 10 minutes, 15 minutes, 30 minutes, 1 hour, 2 hours, 6 hours, 12 hours, 24 hours, or at any suitable interval for a change in state. The periodicity may be adjusted depending on the time of day, the presence of a person, motions or other activity of a person, and/or other inputs to the automation system 100. For example, an outlet 300 may have an appliance plugged in, wherein initially power is not supplied to the appliance. When the appliance is switched on, the outlet 300 may monitor the state of the appliance continuously, or the outlet 300 may monitor the state of the appliance periodically, such as every 5 minutes. If a person is determined to be in the vicinity of the appliance and not moving, the outlet 300 may, for example, monitor the appliance every 5, 10, 15, 20, 30, 45, or 60 seconds. If the person in the vicinity of the appliance is moving, however, the outlet 300 may monitor the appliance more frequently, such as every 1 second.

If the outlet 300 does not determine that an appliance or other device is connected, e.g., plugged into the socket or otherwise connected wirelessly, the outlet 300 may not conduct any monitoring. The outlet 300 may periodically check to determine whether an appliance is connected, e.g., electrically and/or mechanically, as discussed above.

The outlet 300 may comprise a device that is included in a junction box or coupled to an electrical system, e.g., to provide power or another utility or device. By way of example, this could be a device included in a ceiling junction box that is coupled (e.g., wired) to a ceiling fan, a device included inline to power outside flood lights, a device that monitors and/or controls the flow of natural gas to a furnace, among other variations.

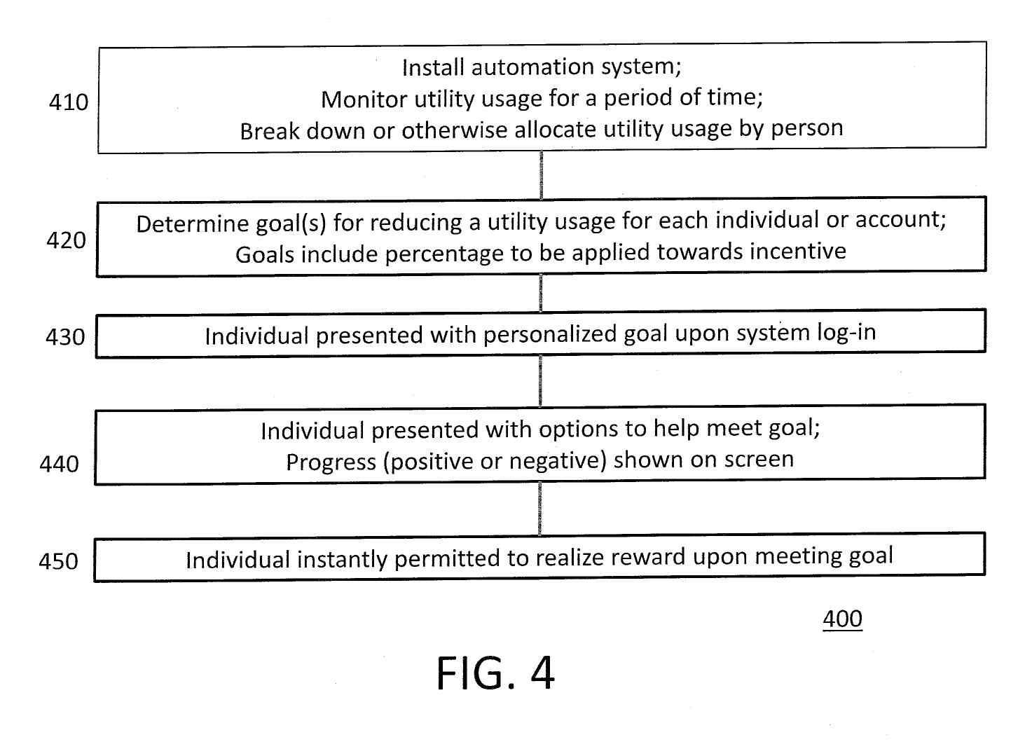

FIG. 4 shows a flowchart that outlines an exemplary method of monitoring and/or incenting an adjustment in utility use. In step 410, an automation system, e.g., system 100, may be installed or otherwise provided in a structure or location. The system 100 may identify each person who resides or frequents the location and create an account for each person. The system 100 may automatically identify each person via any of the methods discussed above. In some embodiments, for example, the system 100 may identify a person by capturing one or more images of the individual and comparing the images to a database locally or remotely connected, e.g., to the Internet In some embodiments, accounts may be set up by an authorized user or operator. For example, a resident or visitor of a home may be identified by the system 100 upon touching a surface with fingerprint recognition capability (e.g., a doorknob, an alarm access panel or other wall panel, a light switch, a remote controller, or other surfaces likely to be touched), upon recognition of physical characteristics such as facial features or gestures via images collected by a camera or other imaging device, by association with an identified mobile device such as a smart phone, or by recognition through data collected by one or more other sensors such as, e.g., voice recognition. In some embodiments, the system 100 may identify a person according to location or time of day. For example, the system 100 may identify a person entering the home between 3-3:30 pm on weekdays as a child, and identify a person entering the home between 5:30-6 pm on weekdays as the child's parent.

Once the accounts are set up, system 100 may collect data on usage of at least one utility or other service such as, e.g., telecommunications, data, voice, or broadcast for a period of time, wherein each usage may be assigned or otherwise allocated to one or more persons having accounts, to a general account, or to a visitor's account. An account may be created for each person who lives in or otherwise frequents the location of system 100. When an appliance is turned on, the person activating the appliance may be identified as discussed above, and the amount of utility used by the appliance may be recorded and/or charged to the identified person's account. As an example, a person taking a shower may be charged for the water usage, as well as the utility used to heat the water. The longer the shower, the higher the charge that would be attached to the person's account. In some embodiments, an account may only be charged or debited for utility use or consumption up to and/or exceeding a limit. Utility use may be charged in any suitable units, including, e.g., monetary units, quantity of an utility, or other use units.

In some embodiments, utility usage may be charged to a general account, as alluded to above. For example, using a utility such as running a HVAC system when no one is in the house may be charged to a general household account. If a single person is home, however, and use of the utility exceeds a threshold or default setting, e.g., the HVAC is set to a less than efficient energy setting, the difference between the default setting and the less than efficient energy setting may be charged to the single person's account. For example, an HVAC system may be set so that a home is cooled to 75 degrees F. at night, and during the morning, but may be set to 80 degrees F. during the day when the house is typically not occupied. If a member of the household such as a school age child returns home, and the child resets the thermostat to a cooler temperature, then the difference in utility usage may be changed to the child's account. Suitable overrides may be in place to account for abnormal conditions, such as exceedingly hot days, or as programmed by an authorized user or other system operator.

In some embodiments, a utility usage may be divided between two or more accounts. For example, if a single person is watching a TV or playing a video game, the utility usage for that device would be charged to the single person's account. If two people are watching a TV or playing a video game, however, the utility usage may be divided such that a portion of the utility use is charged to each person's account. The utility use may be divided equally (e.g., 50% to each of two people or 25% to each of four people) or may be apportioned in relatively larger or lesser amounts depending on the utility and/or characteristics or identities of each person. Allocation may be done based on programming, by type of use, and/or by location. For example, if a parent is preparing dinner with her child and using power to heat an oven, the power use may only be charged to the parent's account or a general account, regardless of whether the child is also present, or a larger portion of the power use may be charged to the parent's account than to the child's account. Similarly, a charge for utilities associated with streaming music (e.g., electricity, Internet use, and/or other data or utility use) may be allocated to a particular person within the home who often streams music, or utility use within a storage shed in the backyard may be allocated to the primary member of the household to frequent the shed.

Further, a utility may be allocated in different portions according to a type of use, delivery device, and/or location of use. For example, water use from a bathroom faucet may be differentiated from water use from a shower head, e.g., via a flow meter or other suitable sensor or measurement device associated with each appliance in the bathroom, and allocated differently. Similarly, electricity used to power a TV in the living room may be allocated differently than electricity used to power a computer in the same room, e.g., wherein the system 100 may identify and distinguish each device and its associated utility use.

Should a person such as a friend, acquaintance, or business associate be visiting the home, utility usage may be charged to an account set up for the visitor, or may be charged to the account of the person who invited the person to the home. Permission to set up new accounts and/or to change the rules or procedures for charging accounts may be reserved for authorized users of system 100.

In step 420, one or more goals may be determined and assigned to each person or account. Visitor accounts may be linked to a suitable payment account, such as a credit card, Paypal account, or the visitor's home utility account. In some embodiments, the goal(s) may be to reduce usage by a specific amount of utility, such as kilowatt hours (KWh) or gallons of water. In some embodiments, the goal(s) may be in terms of dollars such as saving an amount of money spent on utility use, may be in terms of percentage such as reducing utility use by a percentage with respect to a baseline, e.g., an average amount of utility used or an average amount of money budgeted to spend on utilities, or may be in terms of time spent using a service or utility (e.g., Internet, TV, smartphone data). For example, a child in a family may be given a goal to reduce his usage of utilities (water, gas, electricity, etc.) by 10% within a given period of time. The goal may be to reduce usage of each utility by 10%, to reduce the value of the utilities used by 10%, to reduce usage by a fixed amount (for example, reduce water usage by 100 gallons), to reduce usage to a fixed amount, to reduce the time a utility is used, or any combination thereof. The method of measuring progress towards a goal, e.g., units of utility use, may be individualized and chosen to provide meaningful feedback to each person. The goal may be for a day, week, month, or any other suitable timeframe. Goals may be set individually, that is, a different goal for each person or account, or the goals may be set globally, the same for each person or account. For example, the goal(s) may be shared among two or more persons, or may be tailored and chosen to have a meaningful connection to each person.

The goal(s) for each person or account may be associated with an incentive or reward to be obtained upon meeting the goal(s). The incentive may be measured as a fixed amount or a percentage of the amount of utility that is saved. For example, the incentive may be equivalent to 100% of the amount of utility saved, or greater or less than the amount of utility saved. The goals and incentives may change over time, such as based on a person's utility use. In some embodiments, the goals and incentives may be stepped or progressive, e.g., where greater incentives are earned for larger reduction of utility usage.

Progress toward the goals may also include neutral or negative values for certain utility usage. In some embodiments, utility usage up to a limit or predetermined threshold may be counted as credit or assigned a neutral value, and usage beyond that limit may be counted as debit or assigned a negative value. For example, parents may wish to incent their children to take showers regularly and to brush their teeth. Usage of utilities to take a shower may be counted as credit for a child and progress toward meeting the child's goal. Taking a 5 minute shower may give the child credit toward a goal or may not count toward utilities used, but each minute beyond a limit, e.g., 5 minutes, such as greater than about 15 minutes, may be counted as utilities used and charged to the child's account to detract from progress toward the goal. This would incent children to bathe regularly but limit their use of resources, e.g., by encouraging them not to take 30 minute showers. Utilities used to brush teeth may not count towards utilities used or may be counted as credit when less than a limit, but leaving the water running while brushing teeth may be counted towards utilities used, e.g., debited or reflected as a negative value in a person's account. Thus, setting goals can be used to incent appropriate usage of utilities and to encourage or otherwise modify behavior.

In step 430, each person may log-in to system 100, whereupon the person may be presented with his/her personalized goal, e.g., via a dashboard or other interface display associated with the person's account. Logging into system 100 may be accomplished by facial recognition, voice recognition, keyed inputs or other user input, or by other methods known in the art. For example, a person may log-in via controller 110, wherein controller 110 may be a tablet attached to a wall or on a table or counter top. Controller 110 may log a person in when the person walks past the controller 110 and provide the person with a quick update how they are progressing towards their goal, e.g., by displaying the person's individualized progress.

Once a goal is assigned to a person, system 100 may determine an incentive item or reward for each person. Additionally or alternatively, the incentive item may be set by an authorized user, chosen by each person, or selected by system 100. For example, system 100 may select incentive items from a database and may use information known about each person. Information may be obtained from social networking sites or other sources of information, may be provided by an authorized user, or may be assigned based on a person's age, gender, or other identifying characteristics. For example, for a 5 year old child, system 100 may choose baseball cards as a reward; for a 13 year old boy, system 100 may choose games for a gaming system, and for a 16 year old girl, the system 100 may select a gift card for a hobby store where the girl obtains supplies for her wood working hobby. As the person makes progress towards his/her goal (e.g., utility reduction or utility savings goals), the person may be presented with progress they are making towards earning their incentive. For example, a person may periodically log-in to the system 100 to see his/her progress toward the chosen incentive item. Incentives may be credit towards use of another utility, such as utilities most often used or those associated with entertainment or other activities, e.g., Internet time or data, or electricity use.

When the individual is in the vicinity of a device connected to system 100 the system 100 may suggest options to help in meeting the goal, in step 440. For example, if one child is in a first room watching TV, and a second child is in a second room watching the same show, the system 100 may recommend to the children that they watch TV in the same room and turn off the TV in the other room. If a child is playing a game on a gaming system, system 100 may inform the child how much time he/she can afford to play the game and still earn the incentive item. The system 100 may recommend another activity that uses less utilities and may help the child make faster progress towards the goal. As progress is made toward the goal, it may be displayed on a screen or other suitable user interface. Progress may be presented to inform the person of being on track to earn the incentive item within a given period time. For example, one or more components of the system 100, e.g., controller 110, mobile device 170, a television, a computer, a tablet, and/or other components may inform the person of being behind or ahead of a usage trend that will allow the person to earn an incentive item.

Persons may earn credit towards a goal by performing various tasks in more energy efficient ways. For example, a child that washes dishes by hand instead of loading a dish washer may earn credit towards his goal. Other tasks that may use less utilities include air drying laundry, sweeping with a broom instead of a vacuum cleaner, etc. In some embodiments, system 100 may allow an authorized user to input tasks and an estimated utility usage associated with the tasks. For example, a user may input air drying clothes and receive credit for the utilities saved in not using the dryer. In some embodiments, data entered may require validation before credit is assigned to a person's account. For example, a child may log-in to system 100 and input data for sweeping the floor, but credit for utility savings may not be assigned to the child's account until the child's parent approves the credit.

In step 450, once the person has met his/her goal and earned the chosen incentive item, the person may be immediately permitted to obtain the incentive item and realize the reward. For example, the system 100 may enable the person to purchase the earned incentive item, e.g., by charging the purchase to an authorized account.

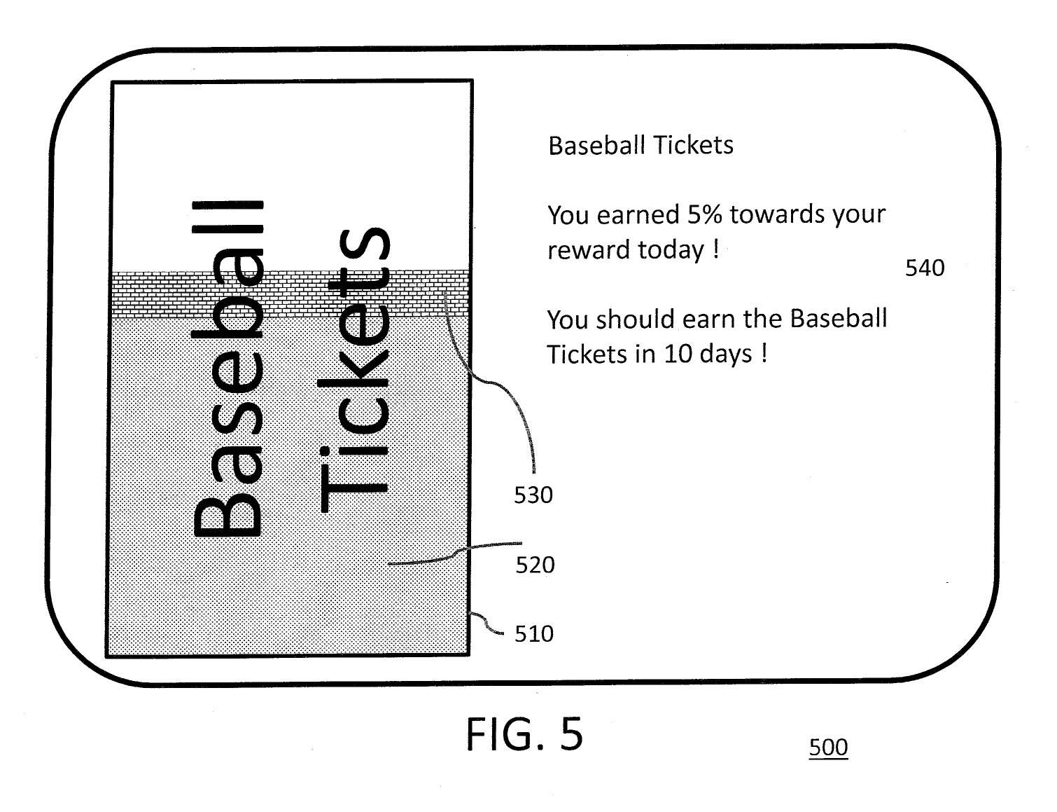

FIG. 5 shows an example of a user interface 500 (which may include a portion of a dashboard and/or controller 110) for monitoring progress towards a goal. When a person known to the system 100 is in the vicinity of a device of system 100, e.g., the person views a device such as controller 110 or mobile device 170, the device may identify the person and display information regarding progress towards the person's goal. User interface 500 may include a graphic 510 representing the incentive that the person is working to earn. Progress may be presented, for example, as a total percentage of the item earned 520 and/or as a percentage earned within a period of time 530, such as on the day the person views the user interface 500, within the previous 12 hours or 24 hours, or recently, e.g., since the person last logged into system 100. As shown in FIG. 5, for example, the person viewing the user interface 500 may be a child who is trying to earn baseball tickets. If the child has gone without playing a video game, and has earned progress towards tickets, the progress may be displayed as area 530. Other information 540 such as text and/or other graphics may be presented to the person to monitor progress. For example, the user interface 500 may provide an estimate of when the person will meet a goal and earn the incentive item. In some embodiments, the user interface 500 may present options or suggestions for activities for improving progress towards earning the incentive item.

Charitable institutions, such as, for example, churches, schools, the Red Cross, the United Service Organizations, etc., may offer challenges to raise money. For example, participants in a challenge may determine an expected usage of utilities for a period of time, such as, for example, one month. Participants may work to reduce usage of utilities for the period of time according to any of the methods discussed above, via system 100. At the end of the period of time, an amount of utility savings may be determined by comparison to the expected utility usage and set aside for charitable donation. For example, the person responsible for paying bills or other representative of the participants in the challenge may pay the utility charges incurred and donate any savings from reduction in usage to the chosen charity.

By way of example: A household may respond to a challenge to donate to the Wounded Warrior Project, a non-profit that works with soldiers that have returned home from active military service. The household may have budgeted $500 for utilities, including $300 for electricity, $100 for natural gas, and $100 for water for the month of May. Other utilities could be included in the total. Members of the household may then work to reduce their utility usage throughout the month. At the end of May, the actual charges may be $250 for electricity, $75 for natural gas, and $80 for water, for a total of $405. The total savings of $500−$405=$95 may be donated to the Wounded Warrior Project. The system 100 may be assigned the task of paying utility bills, and system 100 may automatically send the savings amount to be donated at the end of the designated time period, e.g., in addition to paying the utility bills. For example, system 100 may pay utility bills via an appropriate payment account (e.g., credit card or bank account such as via automatic bill pay) and may donate to a charity from the same payment account or from another linked account.

Groups such as neighborhoods, schools, school classrooms, or other groups, organizations, or communities may organize a competition to reduce utility usage, save power, and/or otherwise conserve resources. Competitors may determine a baseline power usage from a previous time period and challenged to reduce usage from the baseline within a given period of time. For example, an account may be created for each group with the specified goal of utility reduction. Challengers may set a goal of reducing relative utility usage, e.g., by a specified monetary amount and/or a quantity of a utility. Each person within a group may have an individual account for tracking each group member's utility usage, wherein individuals may monitor their personal use. After the challenge period, the energy or utility saved by each member of a group may be totaled. The totals for each group may be compared, wherein the group with the best total, e.g., the total closest to the group's goal or the greatest utility savings, may be declared the winner. A single automation system 100 may be used for a group competition (e.g., tracking utility use of individual classrooms within a school in which system 100 is installed), or multiple systems, e.g., a first system 100 and a second system (not shown) installed in different locations, may be used to compare utility use by competing groups. For example, the first and second systems may be in communication with each other for comparison, or groups may compare progress towards their utilities usage goals without communication between the systems.

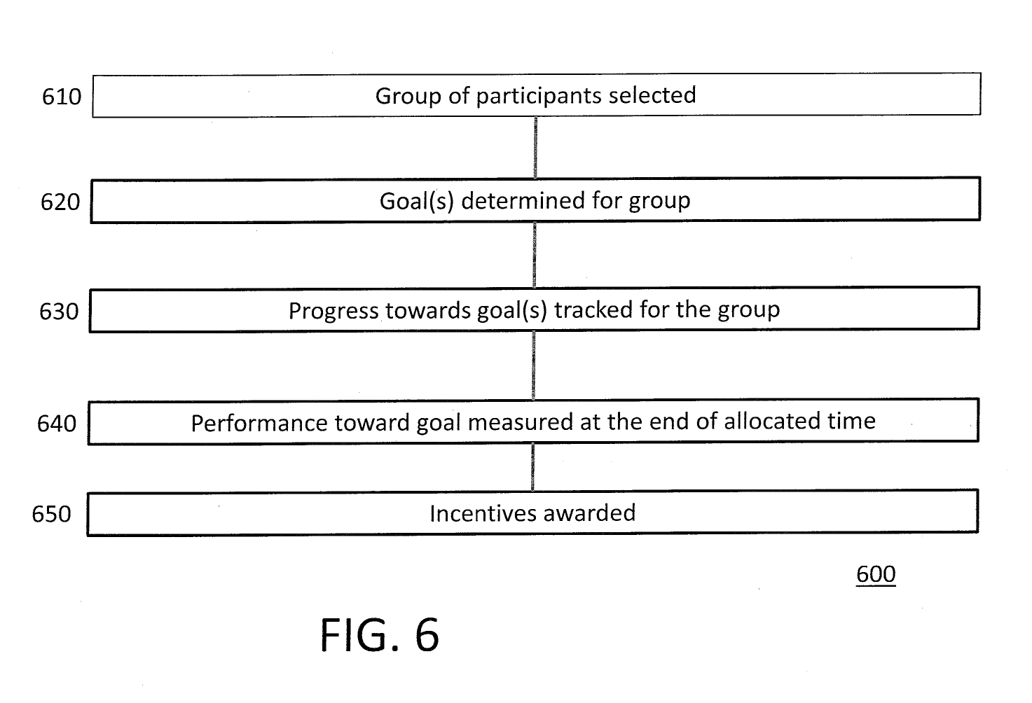

FIG. 6 illustrates an exemplary method 600 of conducting a group competition. In step 610, a group of participants is selected. The group may include, for example, an individual or group of one, a classroom, a school, a neighborhood, a community, a sports team, a club, a church, a business, or a department of a business, among other examples of groups.

In step 620, one or more goals may be determined for each group. The goals may be, e.g., an amount of savings of one or more utilities. The goal may be related to a quantity of one or more utilities, a value of one or more utilities, or both a quantity and value. The goal may be related to a time period, such as, for example, a week or a month. The goal may be related to a time of day, such as reducing an amount of electricity or other utility, e.g., water, used during peak hours.

Utility usage during peak periods, such use of water for taking a shower in the morning, or electricity use for air conditioning during the heat of the afternoon can place a strain on municipal utilities services. Incenting the reduction of utility use during these peak periods can be of value to the utility provider and save valuable resources.

In step 630, progress toward the goal may be tracked for each group, e.g., via system 100 and according to any of the methods described above. Progress of all group members may be made available to all group members, or each group member may be able to monitor his/her progress privately.

At the end of the competition period, in step 640, the progress of each group may be assessed to determine which group or groups met their goals. It may also be determined which group(s) exceeded their goals by the greatest margin. In step 650, incentives for meeting and/or exceeding goals may be awarded.

The present disclosure may be useful in allocating individualized utility consumption to users in a multi-user structure such as, e.g., a nursing home, a hospital, a dorm, an apartment building, a vacation rental, or a hotel. Each person or group, e.g., a family, may have an associated utility account to which the person's or group's utility use may be allocated, such as for billing the utility use. A patient in a hospital, for example, may be charged only for his/her utility use, e.g., an amount of electricity, water, telecommunications data or services consumed by the patient or otherwise consumed in the patient's room. The patient therefore may not be charged for other utility use throughout the hospital, such as electricity for powering diagnostic equipment or other buildings that the patient does not use. Similarly, each guest in a hotel may have an account, wherein each guest's utility use may be allocated to his/her account such that the guest is charged only for his/her utility use. Additionally or alternatively, each hotel room may have an associated account such that utility use by all guests within the room during their stay is charged to the room account. Allocation of utility use may results in cost savings, and may allow an owner/manager of a hotel to charge a lower base rental rate.

It is understood that the present disclosure is not limited to the particular forms, embodiments, and/or examples illustrated. Alternatives and/or modifications of the systems, devices, and methods disclosed herein are contemplated and may be made without departing from the spirit and scope of the disclosure. Further, elements of any embodiment may be added and/or combined with any elements of another embodiment.

Embodiments of the present disclosure may be used in connection with any structure, including, but not limited to, homes, offices, businesses, schools, churches, sporting complexes, hospitals, shopping centers, and manufacturing facilities. In addition, at least certain aspects of the aforementioned embodiments may be combined with other aspects of the embodiments, or removed, without departing from the scope of the disclosure.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

We claim:

1. An automation system, comprising:
a controller for determining a consumption of at least one utility, the controller comprising:
a processor; and
a database including a first account associated with a first utility consumer, wherein the first account includes a goal related to consumption of the at least one utility;
a delivery device for delivering a supply of the at least one utility; and
a measurement device for measuring consumption of the at least one utility;
wherein the controller is configured to associate the consumption of the at least one utility with the first account and provide feedback related to the first account expressed in units related to the first utility consumer.

2. The automation system of claim 1, wherein the units are determined from a server, a social network, an authorized user, or the first utility consumer.

3. The automation system of claim 1, wherein the feedback is related to an amount of the at least one utility consumed or saved by the first utility consumer.

4. The automation system of claim 1, further comprising at least one sensor for identifying the first utility consumer.

5. The automation system of claim 1, wherein the feedback includes progress by the first utility consumer towards at least one of meeting the goal or earning a reward.

6. The automation system of claim 1, wherein the database includes a second account and the controller is configured to divide the consumption between the first and second accounts.

7. The automation system of claim 1, wherein the controller is configured to allocate an amount of the at least one utility consumer by a second utility consumer to the first account.

8. The automation system of claim 1, wherein the at least one utility includes electricity, water, natural gas, telecommunications data, or telecommunications services.

9. The automation system of claim 1, where the feedback is related to a value of the at least one utility consumed.

10. The automation system of claim 1, wherein the controller is configured to determine an amount of the at least one utility saved and donate the amount to a charity.

11. The automation system of claim 4, wherein the progress is measured by an amount of the at least one utility consumed by the first utility consumer such that
consuming less than a first amount increases progress towards meeting the goal or earning the reward; and
consuming more than or equal to the first amount decreases progress towards meeting the goal or earning the reward.

12. The automation system of claim 4, wherein the progress is measured by an amount of the at least one utility consumed by the first utility consumer such that
consuming less than a first amount of the at least one utility decreases progress towards meeting the goal or earning the reward;
consuming between a first amount and a second amount of the at least one utility increases progress towards meeting the goal or earning the reward; and
consuming more than the second amount decreases progress towards meeting the goal or earning the reward.

13. The automation system of claim 1, further comprising a user interface for displaying the feedback, wherein the user interface includes a computer, a tablet, a television, or a mobile device.

14. The automation system of claim 3, wherein the feedback includes options for reducing the amount of the utility consumed or increasing the amount of the utility saved by the first utility consumer.

15. An automation system, comprising:
a controller for determining consumption of at least one utility, the controller including:
a processor; and
a database including a first account associated with a first utility consumer;
a delivery device for delivering a supply of the at least one utility;
a measurement device for measuring a rate of delivery of the at least one utility;
an outlet for providing electrical energy to an electrical device; and
at least one sensor;
wherein the controller is configured to associate the consumption with the first account and provide feedback related to the first account.

16. The automation system of claim 15, wherein the at least one sensor includes a camera, a motion sensor, a sound sensor, a light sensor, a temperature sensor, a pressure sensor, a touch sensor, a radiofrequency (RF) sensor, an infrared (IR) sensor, or a power monitor.

17. The automation system of claim 16, wherein the controller is configured to identify the first utility consumer based on data obtained by the at least one sensor.

18. The automation system of claim 16, wherein the at least one sensor is configured to detect an electrical device coupled to the outlet.

19. A method of monitoring utility consumption, the method comprising:
delivering a supply of at least one utility;
monitoring consumption of at least one utility with a measurement device, wherein the at least one utility includes electricity, water, natural gas, telecommunications data, or telecommunications services;
identifying a first utility consumer based on data obtained by a sensor, wherein the sensor includes a camera, a motion sensor, a sound sensor, a light sensor, a temperature sensor, a touch sensor, a radiofrequency (RF) sensor, or an infrared (IR) sensor;
associating the consumption with an account associated with the first utility consumer, wherein the account is stored in a database; and
providing feedback related to the account, wherein the feedback is related to an amount of the at least one utility consumed by the first utility consumer and progress towards meeting a goal.

20. The method of claim 19, wherein:
consuming less than a first amount of the at least one utility increases progress towards meeting the goal; and
consuming more than or equal to the first amount decreases progress towards meeting the goal.
